(19) United States
(12) Patent Application Publication
(10) Pub. No.: US 2008/0268341 A1
(43) Pub. Date: Oct. 30, 2008

(54) HIGH POWER BATTERIES AND ELECTROCHEMICAL CELLS AND METHODS OF MAKING SAME

(75) Inventor: Xiaoge Gregory Zhang, Toronto (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: TECK COMINCO METALS LTD., Vancouver (CA)

(21) Appl. No.: 12/041,507

(22) Filed: Mar. 3, 2008

Related U.S. Application Data
(60) Provisional application No. 60/894,836, filed on Mar. 14, 2007.

(51) Int. Cl. H01M 4/42; H01M 2/16; H01M 6/00

(52) U.S. Cl. 429/229; 429/246; 29/623.2

(57) ABSTRACT

This invention relates to novel designs of high power batteries, electrochemical cells, energy storage materials and electrode materials, and processes for manufacturing same. A battery comprising: (a) an alternating stack of one or more anodes and one or more cathodes; (b) one or more non-conducting separators separating the one or more anodes and cathodes; (c) an electrolyte; (d) a current collector extending through the stack; and (e) a casing holding the one or more anodes, the one or more cathodes, the one or more non-conducting separators, the electrolyte and the current collector

### FIELD OF THE INVENTION

This invention relates to novel designs of high power batteries, electrochemical cells, energy storage materials and electrode materials, and processes for manufacturing same. More particularly, the invention pertains to novel designs, materials, and manufacturing processes for high power alkaline batteries. These novel designs have a large anode/cathode surface area thereby allowing high energy utilization efficiency in high drainage applications. Novel fibrous zinc materials for making the anodes for alkaline batteries are also disclosed.

### BACKGROUND OF THE INVENTION

Manufacturers of alkaline and zinc-air batteries and electrochemical fuel cells are constantly seeking improvement in the performance of these electrochemical energy devices. There is an ever-increasing demand for batteries that can provide higher power without unacceptable sacrifices in desirable battery performance characteristics, such as long discharge life (high capacity), long storage life, resistance to electrolyte leakage, and ease of manufacturing. There has been continual effort in the industry to develop better zinc particulate material for alkaline-zinc batteries, zinc-air batteries and fuel cells. Efforts have been made to improve the particle size distribution, to change alloy composition, or to use different forms of particulates such as zinc ribbons, flakes, or wires in such devices. Efforts have also been made to increase the interface area between the anode and cathode.

Zinc powder produced by an atomizing process has been the dominant material used as anodes for alkaline and zinc-air batteries that are available in the marketplace. Much relevant prior art can be found in the patent literature and new patents for purported improvements are continually being issued. For example, U.S. Pat. No. 6,521,378 B2 discloses a zinc anode using powders that have multi-modal distribution of zinc-based particles. WO 56098 A2 discloses zinc particle agglomerates that use a low melting metal binder to make agglomerates of powder particles. U.S. Pat. No. 6,284,410 and US 2003/0203281 pertain to control of particle distribution of atomized powder to improve performance under high discharge rate.

There have been attempts to improve the high power performance of alkaline cells by using a non-round interface between cathode and anode to increase the interface area. Under similar kinetic conditions, a larger interface area generally means a larger discharge capacity for a higher discharging power. In one prior art disclosure, a zinc anode has a zigzag shape made of a strip material (U.S. Pat. No. 4,175,168). A problem with this construction is that it would be difficult for such a zigzag shape to be matched with a cathode to fill the round shape of a cell can.

In another example, which is disclosed in application WO 2004/027894, a butterfly cross-sectional shape for the anode design is used for increasing the interface area. However, considerable complexity for manufacturing such a shape in a high speed process exists because precise alignment of cathode and anode is required. Furthermore, the thickness of anode and cathode material within such a cell is not uniform, and could compromise the utilization efficiency under certain discharging profiles.

In other patent applications, several different cross-sectional geometric shapes for increasing interface areas are disclosed (US 2005/0048363, US 2005/0244712, US 2005/0048362, and US 2005/0153197). However, cells with these different designs have non-uniform material distribution and fabrication processes are significantly complicated.

A wound cell (jelly-roll cell) has been practiced for rechargeable batteries. However, it is very difficult to make a wound cell with zinc powders. There have been efforts to make wound cells with zinc powder using binding agents and supporting grids (JP 05222879 and JP 05222881). A wound cell using a sheet made of zinc fibers has been recently disclosed in the subject inventor's U.S. Pat. No. 7,291,186 B2, issued 6 Nov. 2007. A corresponding PCT application was published on 11 May 2006 as WO 2006/047852 A1.

The various methods for increasing the interface area between cathode and anode, as discussed in the prior art above, provide only limited improvements to the performance of alkaline cells. Such methods can significantly complicate manufacturing processes and increase costs. Thus, a method is required that would greatly increase interface area and performance, and yet be compatible with current manufacturing processes.

The foregoing examples of the related art and limitations related thereto are intended to be illustrative and not exclusive. Other limitations of the related art will become apparent to those of skill in the art upon a reading of the specification and a study of the drawings that follow.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements. It is understood that in this application, the terms “battery” and “cell” are interchangeable and among other things include high power batteries, electrochemical cells, alkaline cells, rechargeable cells and fuel cells.

Disclosed herein are novel designs and methods of manufacture for increasing internal cell interface area that can be adapted to existing battery production processes through certain modifications. For purposes of discussion, the following comments relate to alkaline cells, notwithstanding that the overall invention can pertain to other types of batteries or cells. One novel feature of the invention is that instead of the cylindrical anode and annular cathode design currently employed in alkaline cells, alternating anode and cathode discs are used. Such a design allows the interface area to be much greater, 40% or more in an AA cell format and even greater in D cell format, than the current bobbin design. Furthermore, unlike other cell designs as disclosed in the prior art mentioned above, the cathode and anode material used in the cell according to the invention is uniform in dimension, thereby allowing good material utilization during discharge. The multiple alternating disc configuration provides the freedom to design cells with different interface areas and thus different power levels that may be desirable for various applications. In accordance with the present invention, cells according to the invention can be designed and constructed of any suitable material that can be made into disc form. Fibrous materials are particularly advantageous as they can be easily fabricated into controlled and dimensionally stable designs.

One aspect of the invention is directed to a battery comprising: (a) an alternating stack of one or more anodes and one or more cathodes; (b) one or more non-conducting separators separating the one or more anodes and cathodes; (c) an electrolyte; (d) a current collector extending through the stack; and (e) a casing holding the one or more anodes, the one or more cathodes, the one or more non-conducting separators, the electrolyte and the current collector.

The one or more anodes can comprise a fibrous material. The fibrous material can be fibers, filaments, threads or strands of Zn or zinc alloy. The zinc alloy can be an alloy of Zn and one or more metals selected from the group consisting of Bi, In, Ca, Al, Mg, Ga, Sn, Pb, Cd and Hg. The fibers, filaments, threads or strands can be compressed. The fibers, filaments, threads or strands can be compressed to form a disc, plate or sheet.

The one or more anodes can comprise sintered zinc powder discs, plates or sheets, porous, perforated or solid material of Zn or zinc alloy, or a bonded material. The bonded material can comprise a polymer-based binding agent. The one or more anodes, the one or more cathodes and the one or more separators can be disc-shaped.

The separator can comprises one or more layers of a separating material enveloping each of the one or more anodes.

The one or more cathodes can be disc-shaped and can be enveloped with a separator or an ionic conductive polymer layer, or can be micro coated with a polymer with micropores except for the area that is in contact with the casing. The one or more cathodes can include a current collector layer. The current collector layer can be a perforated sheet or mesh.

The battery can be an alkaline battery, an alkaline zinc manganese dioxide battery or a chloride zinc manganese dioxide battery, a primary or secondary zinc-nickel battery. The battery can be a cylindrical battery of an AA, C or D format. The one or more anodes can comprise a non-fiber material.

Another aspect of the invention is directed to a method of manufacturing a battery, the method comprising: (a) fabricating a plurality of anodes with holes therein; (b) fabricating a plurality of cathodes with holes therein; (c) stacking the anodes and cathodes into a container in an alternating pattern and providing a non-conducting separator between the adjacent anodes and cathodes; (d) filling the container with electrolyte; (e) inserting a current collector into the holes in the anodes and cathodes; and (f) sealing the container.

Step (a) can include compressing fibrous zinc or fibrous zinc alloy to form the anodes. Step (c) can be replaced with enveloping each of the plurality of anodes in a non-conducting separator before stacking the anodes and cathodes into a container in an alternating pattern.

The one or more cathodes can be disc-shaped and can be enveloped with a separator or coated with an ionic conductive polymer layer, or can be coated with a polymer with pores except for the area that is in contact with the container. The coating may be a polyvinyl alcohol.

In addition to the exemplary aspects and embodiments described above, further aspects and embodiments will become apparent by reference to the drawings and by study of the following detailed descriptions.

### DRAWINGS

Exemplary embodiments are illustrated in referenced figures of the drawings. It is intended that the embodiments and figures disclosed herein are to be considered illustrative rather than restrictive.

FIG. 1 illustrates a schematic of the interior of a cylindrical cell constructed of a can which holds a stack of alternating anodes, separators and cathodes.

FIG. 2 illustrates a schematic of typical steps involved in the assembly of a cell using alternating disc anodes, cathodes and separators contained in a can.

FIG. 3 illustrates three isometric views of (1) the geometry of a cylindrical zinc anode with anode cylinder and cathode ring, (2) a disc anode, and (3) a cathode disc.

FIG. 4 illustrates a graph of a discharge curve for a cell with an alternating stack of seven anode discs and eight cathode discs compared to a conventional commercial cell.

FIG. 5 illustrates an isometric view of a disc cathode having a layer of metal to act as a current collector.

FIG. 6 illustrates a schematic section of a disc anode wrapped in a separator material.

FIG. 7 illustrates a schematic of a cathode disc wrapped with a separator or coated with an ionic conductive polymer.

### DETAILED DESCRIPTION OF SPECIFIC EMBODIMENTS OF THE INVENTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The use of fibrous material to make solid porous zinc anodes for batteries has been disclosed in the subject inventors' U.S. Pat. No. 7,291,186 B2, issued 6 Nov. 2007. The subject matter of this U.S. patent is incorporated herein by reference. The U.S. patent discloses a solid porous zinc electrode for use in alkaline-zinc batteries, zinc-air batteries and fuel cells. The electrodes comprise specific zinc filaments, fibers, threads or strands which are compressed into a physically-stable wooly mass to form an electrode with a controlled geometrical shape and porosity distribution. Differential densification incorporates ribs, borders, grids or tabs for good structural integrity, mechanical strength, electrochemical behavior, and electrical conductivity. Pressing in a mold or rolling of a compressed sheet provides an anode with a large anode/cathode interface area and a complex geometry. The filaments of controlled dimension and composition are preferably made by spin forming from molten zinc alloys. Such anodes are not susceptible to breakage, have a long storage life and can be used in high rate discharge applications. The solid porous electrode allows independent control of surface area and porosity over a wide range, while maintaining electrical connectivity of all zinc fibers. No gelling agent is necessary. The advantage of a solid electrode made of wooly material is that each fiber is physically connected and linked to a number of other fibers in a dimensionally-stable and solid form. The density and porosity can be controlled by the degree of confinement of the wooly material through mechanical pressing. This allows the fabrication of a conductive zinc anode with a wide range of porosity.

Use of fibrous electroconductive materials allows for independent control of connectivity, electrode conductivity, porosity, surface area, mechanical stability, and form factor (shape and dimension) of anodes. Such features greatly improve the performance and economics of batteries or fuel cells. Porosity can be varied over a wide range with surface area and furthermore both surface area and porosity can be varied over a wide range depending on the diameter of the fibers used. Such is not the case for atomized zinc powder, where porosity can vary only slightly with surface area.

A key parameter for high power performance in a battery or cell is a large interface area between anode and cathode. Conventional cell designs, with a cylindrical anode surrounded by an annular cathode ring, have limited interface area and consequently have relatively poor high power performance capability. With the subject invention, different designs can be employed to achieve higher interface areas compared to conventional cylindrical designs.

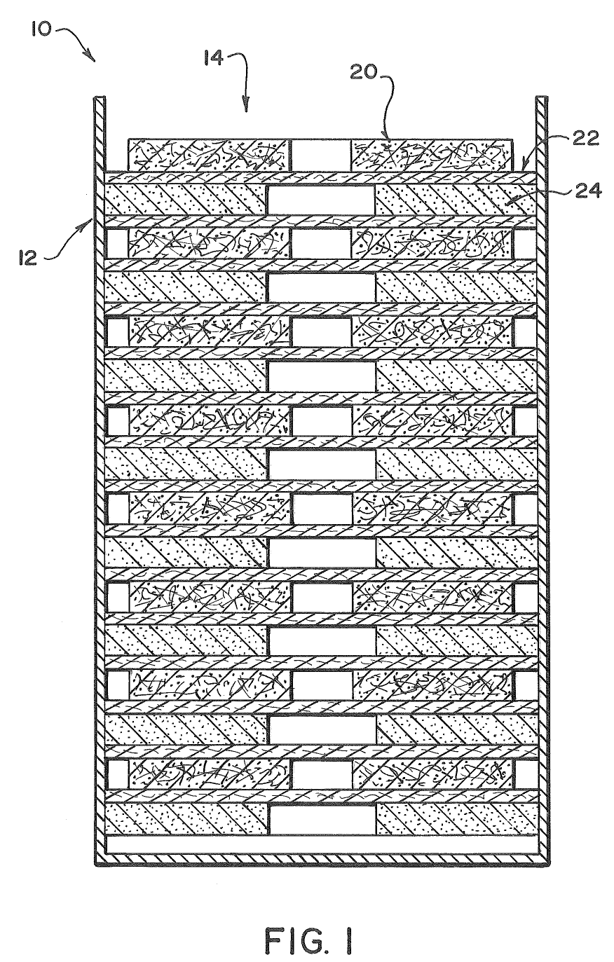

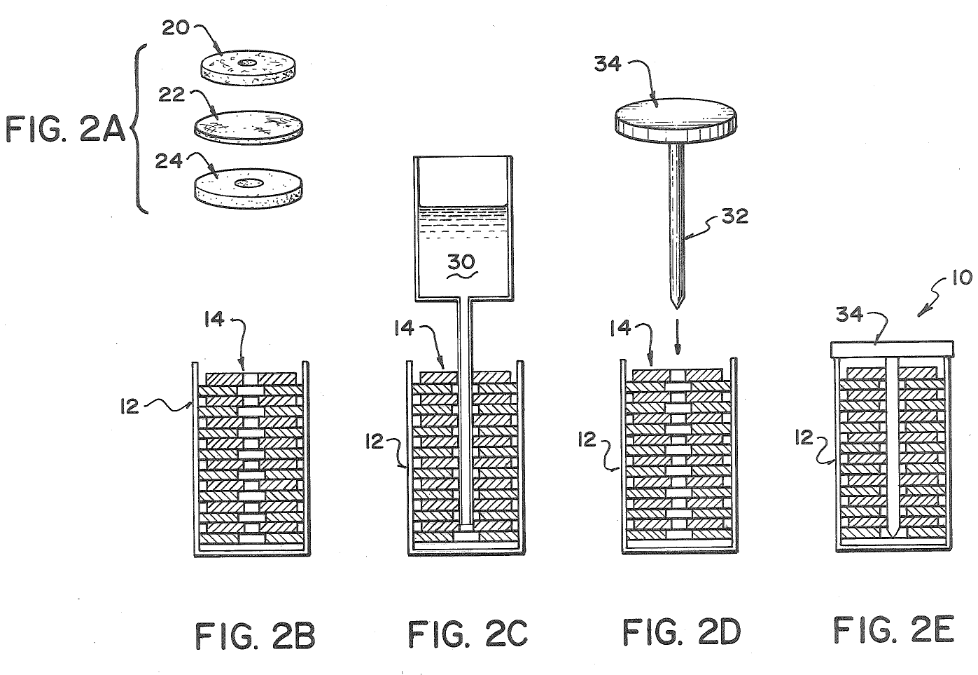

One embodiment of the new cell design using disc anodes and cathodes is illustrated in FIG. 1, which illustrates a schematic of a cylindrical cell constructed of a can which holds a stack of alternating anodes, separators and cathodes. This design provides large interface areas as well as flexible variation of the interface areas by using a different number of anode and cathode discs. The design is compatible with existing battery assembly processes. FIG. 2 illustrates a schematic of the possible steps involved in the assembly of a cell using alternating disc anodes, cathodes and separators installed in a can. After electrolyte is injected into the can, a current collector and a cap are installed and the cell is sealed.

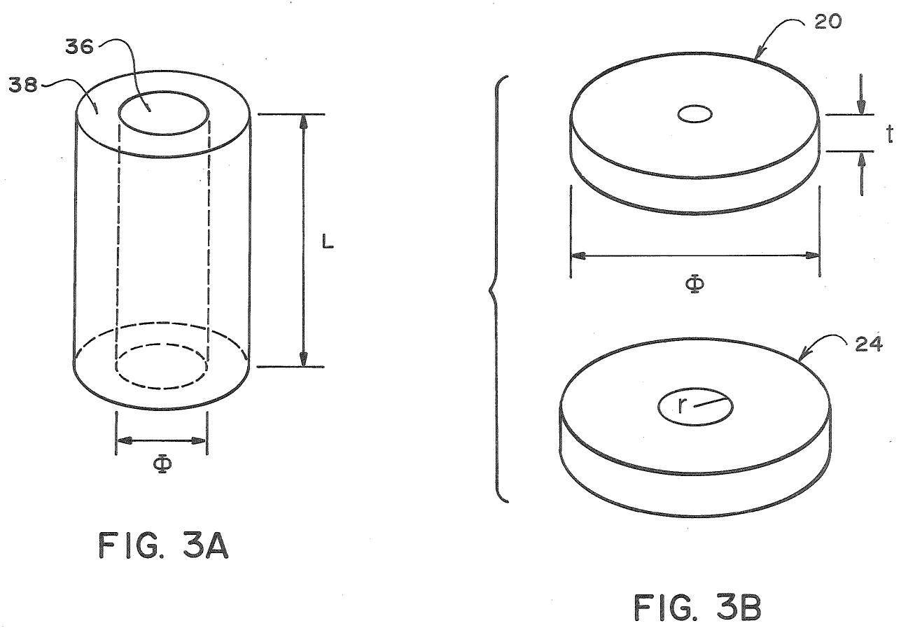

FIG. 3 illustrates an isometric view of the geometry of a cylindrical zinc anode constructed of an anode cylinder and cathode ring according to a conventional cell. FIG. 3 also illustrates a disc anode and a disc cathode according to an embodiment of the present invention. The anode/cathode interface area equals 3.14 ΦL, which, for example, is approximately 3.14×0.78 cm×4.2 cm=10.3 cm² for a conventional AA cell. For a disc electrode, the interface area for one side of an anode equals one surface area of the zinc anode, which is smaller than the metal can cathode to avoid contacting the metal container, minus the area of the hole for the cathode. This is represented by the equation 3.14((½Φ)²−r²). For example, for an AA cell, when the anode disc diameter is taken as 1.28 cm and that of the center hole as 0.3 cm, it becomes 3.14×(0.64²−0.15²)=1.2 cm². Thus, nine disc interfaces have a larger interface area than one interface area of a conventional design. If a cell according to the invention has 7 anode discs and 7 cathode discs, it has 13 anode and cathode interfaces and a total interface area of 15.6 cm², which is 51% larger than a conventional cylindrical cell design. If 9 anodes and 9 cathodes are used, the area is about 100% larger. Assuming the same kinetic behavior for the active materials, the stacked disc design according to this embodiment of the invention provides very significant improvement in high power performance situations compared to conventional cells.

The advantage inherent in the invention is even greater for larger format cells such as C and D cells. For a C cell, the cylindrical anode and cathode interface area in a conventional design is 18.5 cm². The area of the interface for one side for the disc design, considering cell assembly issues such as the middle hole and smaller anode, is 4.2 cm². Therefore, only 5 anodes and 5 cathodes are required to have an interface area 100% larger than the conventional design. A cell with 7 anodes and 7 cathodes according to the invention gives 200% more interface area. For a D cell, the conventional cylindrical anode has an interface area of 32 cm² while that of one disc in a cell according to the invention is 7 cm². A stack of 5 anode discs and 5 cathode discs provides a total interface area of 63 cm², which is about 100% larger than a conventional cylindrical design. More than 300% improvement is possible if 10 anodes and 10 cathodes are used for a D cell.

Table 1 below provides as examples a comparison of interface area for a disc anode according to the invention and cylinder anodes for conventional AA, C and D cells. The values in Table 1 are approximate and may vary to some extent depending on the actual cell and electrode design.

TABLE 1

| Cell | Disc Anode | Cylinder Anode |
|---|---|---|
| Type | One interface area, cm² | Interface area, cm² |
| AA | 1.2 | 10.3 |
| C | 4.2 | 18.5 |
| D | 7.0 | 32 |

The cathode ring of a commercial AA cell has a typical inner diameter of 0.78 cm, an outer diameter of 1.32 cm and a height of 4.2 cm. A C cell cathode ring has a typical inner diameter of 1.9 cm, an outer diameter of 2.45 cm and a height of 3.8 cm. A D cell cathode ring has a typical inner diameter of 2.1 cm, an outer diameter of 3.22 cm and a height of 4.8 cm.

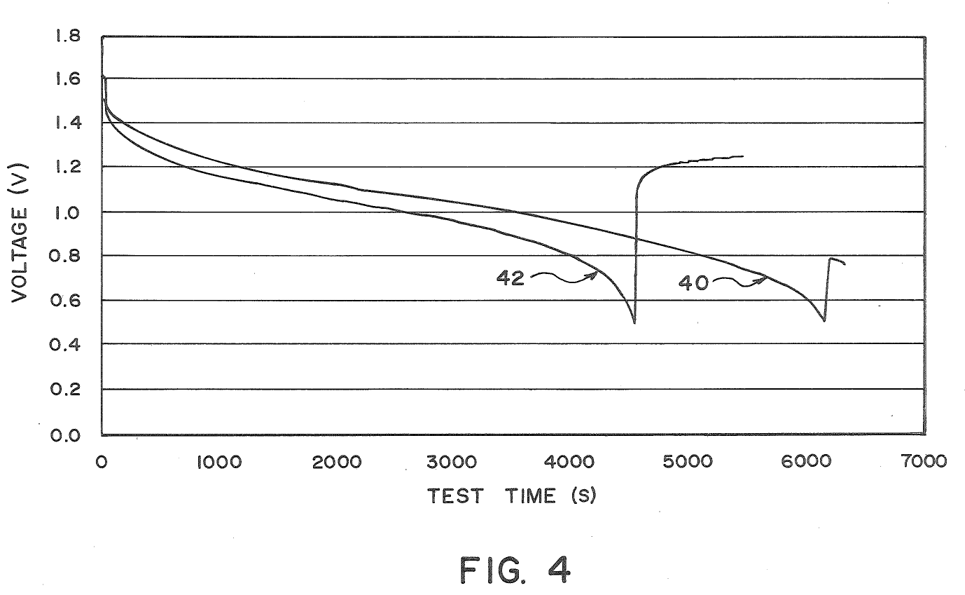

FIG. 4 illustrates a plot of a discharging curve for a prototype AA cell according to the invention with a stack of 7 zinc anode discs alternating with 8 cathode discs, compared to a conventional commercial cell. Table 2 shows the details of the prototype.

TABLE 2

| | | | |
|---|---|---|---|
| Anode | Zinc fiber disc: | | |
| | Weight | 0.6 | g |
| | Thickness | 2.0 | mm |
| | Average fiber length | 18 | mm |
| | Average fiber diameter | 0.11 | mm |
| | Enveloped in a separator | | |
| | Number of zinc discs | 7 | |
| Cathode | Disc: | | |
| | Mixture: | | |
| | Manganese dioxide | 84 | wt % |
| | Graphite | 9.4 | wt % |
| | 35% KOH | 6.5 | wt % |
| | Weight | 1.2 | g |
| | Thickness | 2.8 | mm |
| | Number of discs | 8 | |
| Electrolyte | 35% KOH | | |
| Separator | Celgard, 3501-0708E-A | | |

The capacity at a 0.8 V cutoff voltage is 1.42 Ah, which is 31% greater than the conventional commercial cell. Improved performance should result when a cell of the present design is fabricated by an industrial commercial process with high quality control. According to mathematical calculations, 7 anode discs and 8 cathode discs give more than 50% more interface area than the conventional cell. This should give 50% better discharging capacity if the materials of the prototype display similar kinetics as the conventional cell.

An important factor for the feasibility of a cell design according to the invention is the use of fibrous zinc or zinc alloy which permits a wide range of shapes and densities to be used for the anode. The fibrous zinc may, for example, be compressed into a disc, plate or sheet. The zinc alloy may be an alloy of zinc and one or more of the following metals: Bi, In, Ca, Al, Mg, Ga, Sn, Pb, Cd and Hg. It can be envisioned that the anode can also be made of other suitable materials. For example, the anode may be made of non-fibrous materials such as sintered zinc powder. The sintered zinc powder can be formed into discs, plates or sheets, for example. The anode may be made of porous, perforated or solid material of zinc or zinc alloy. The anode may also be made of a suitable material bonded by a binding agent.

### Methods of Manufacture

The overall process for making cells with stacked disc electrodes comprising alternating anode discs and cathode discs is illustrated in FIGS. 1 and 2 and discussed previously. Some specific features, applications and requirements for obtaining desirable results are outlined below:
1. The design can be used for primary as well as secondary batteries.
2. In addition to alkaline batteries, the design can be adapted to other cell chemistries such as nickel metal hydride and lithium batteries.
3. The zinc fibers used for making the solid porous anodes have a nominal diameter between 5 and 1000 μm and a length at least ten times the diameter. Other parameters are given in earlier referenced U.S. Pat. No. 7,291,186 B2, for solid porous zinc electrodes.
4. Zinc alloys can be used for the fibers. It is well known from the prior art that alloys can be used for desirable performance in terms of corrosion resistance and discharging current density. Alloying elements include, but are not limited to, Bi, In, Ca, Al, Mg, Ga, Sn, Pb, Cd and Hg.
5. The zinc fibers may be fabricated from fibers which are spin cast from molten zinc, or from other sources.
6. The wooly, fibrous material can be pressed with or without a die into discs of desired diameter and thickness. Preferably, the middle hole of the zinc anode has a diameter slightly smaller than the diameter of the metal current collector pin such that sufficient mechanical force is required to secure contact between the anode and current collector.
7. Fabricated anode discs, separators, and cathode discs can be alternately inserted one by one in a metal can container, or a preformed stack of anode and cathode discs may be inserted into the container.
8. During stacking or at the end of stacking, electrolyte can be injected into the disc stack through the middle hole. Electrolyte can be added into the can under a vacuum.
9. A current collector and cap assembly can then be inserted into the disc stack, after which the can is sealed.

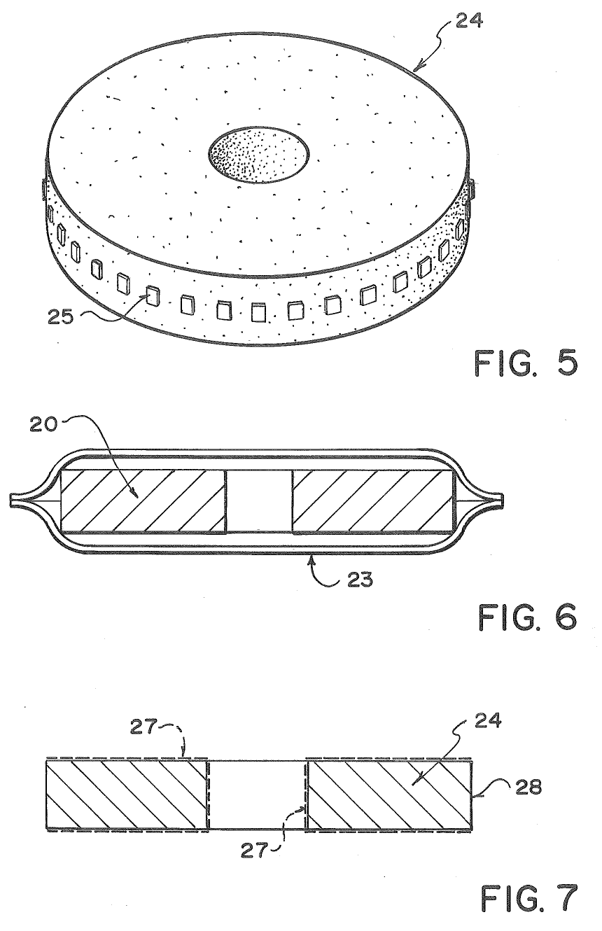

As illustrated in FIG. 5, a metal mesh or perforated sheet can be embedded as a layer within the cathode disc (e.g. a MnO₂ disc) as an additional current collector and/or for structural support, particularly beneficial for larger diameter C and D cells. Some or all of the periphery of the mesh or sheet may protrude from the sides of the cathode disc and contact the interior wall of the container.

In another embodiment of the invention as illustrated in FIG. 6, the anode discs may be wrapped with a separator material or a separator bag prior to cell assembly to reduce the possibility of shorting between the anode and cathode during assembly.

In another embodiment as illustrated in FIG. 7, the cathode discs can be enveloped with a separator, or coated with an ionic conductive polymer layer such as polyvinyl alcohol, or coated with a polymer with pores except for the area that is in contact with the metal can.

The electrolyte can be a solution of NaOH and preferably KOH in the concentration range of 20%-45% vol. and preferably in the range of 30%-40% vol. and may contain additives such as corrosion inhibitors.

It will be understood that while novel designs of alkaline cells are disclosed, the configuration and concepts disclosed can be applied to rechargeable batteries and other types of batteries, as well as fuel cells.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A battery comprising:
(a) an alternating stack of one or more anodes and one or more cathodes;
(b) one or more non-conducting separators separating the one or more anodes and cathodes;
(c) an electrolyte;
(d) a current collector extending through the stack; and
(e) a casing holding the one or more anodes, the one or more cathodes, the one or more non-conducting separators, the electrolyte and the current collector.

2. A battery as claimed in claim 1 wherein the one or more anodes comprise a fibrous material.

3. A battery as claimed in claim 2 wherein the fibrous material is fibers, filaments, threads or strands of Zn or zinc alloy.

4. A battery as claimed in claim 3 wherein the zinc alloy is an alloy of Zn and one or more metals selected from the group consisting of Bi, In, Ca, Al, Mg, Ga, Sn, Pb, Cd and Hg.

5. A battery as claimed in claim 3 wherein the fibers, filaments, threads or strands are compressed.

6. A battery as claimed in claim 3 wherein the fibers, filaments, threads or strands are compressed to form a disc, plate or sheet.

7. A battery as claimed in claim 1 wherein the one or more anodes comprise sintered zinc powder discs, plates or sheets.

8. A battery as claimed in claim 1 wherein the one or more anodes comprise porous, perforated or solid material of Zn or zinc alloy.

9. A battery as claimed in claim 1 wherein the one or more anodes comprise a bonded material.

10. A battery as claimed in claim 9 wherein the bonded material comprises a polymer-based binding agent.

11. A battery as claimed in claim 1 wherein the one or more anodes, the one or more cathodes and the one or more separators are disc-shaped.

12. A battery as claimed in claim 1 wherein in the separator comprises one or more layers of a separating material enveloping each of the one or more anodes.

13. A battery as claimed in claim 1 wherein the one or more cathodes are disc-shaped and are enveloped with a separator, or are coated with an ionic conductive polymer layer or are coated with a polymer with pores except for the area that is in contact with the casing.

14. A battery as claimed in claim 13 wherein the ionic conductive polymer is polyvinyl alcohol.

15. A battery as claimed in claim 1 wherein the one or more cathodes include a current collector layer.

16. A battery as claimed in claim 15 wherein the current collector layer is a perforated sheet or mesh.

17. A battery as claimed in claim 1 wherein the battery is an alkaline battery.

18. A battery as claimed in claim 1 wherein the battery is an alkaline zinc manganese dioxide battery or a chloride zinc manganese dioxide battery.

19. A battery as claimed in claim 1 wherein the battery is a primary or secondary zinc-nickel battery.

20. A battery as claimed in claim 1 wherein the battery is a cylindrical battery of an AA, C or D format.

21. A battery as claimed in claim 1 wherein the one or more anodes comprise a non-fiber material.

22. A method of manufacturing a battery, the method comprising:
(a) fabricating a plurality of anodes with holes therein;
(b) fabricating a plurality of cathodes with holes therein;
(c) stacking the anodes and cathodes into a container in an alternating pattern and providing a non-conducting separator between the adjacent anodes and cathodes;
(d) filling the container with electrolyte;
(e) inserting a current collector into the holes in the anodes and cathodes; and
(f) sealing the container.

23. A method as claimed in claim 22 wherein step (a) includes compressing fibrous zinc or fibrous zinc alloy to form the anodes.

24. A method as claimed in claim 22 wherein step (c) is replaced with enveloping each of the plurality of anodes in a non-conducting separator before stacking the anodes and cathodes into a container in an alternating pattern.

25. A method as claimed in claim 22 wherein the one or more cathodes are disc-shaped and are enveloped with a separator, or are coated with an ionic conductive polymer layer or are coated with a polymer with pores except for the area that is in contact with the container.
